(19) United States
(12) Patent Application Publication
(10) Pub. No.: US 2004/0154669 A1
(43) Pub. Date: Aug. 12, 2004

(54) Second stage pressure reducer for two-stage pressure regulators

(75) Inventor: Roberto Semeia, Lavagna (IT)

Correspondence Address: FRANCO A. SERAFINI, 2455 CAMINITO CARTGATE, LA JOLLA, CA, 92037, US

(73) Assignee: SCUBAPRO EUROPE SRL, Casarza Ligure (IT)

(21) Appl. No.: 10/775,272

(22) Filed: Feb. 10, 2004

(30) Foreign Application Priority Data
Feb. 11, 2003 (IT) IT-SV2003A000005

(51) Int. Cl. G05D 16/06

(52) U.S. Cl. 137/505.46

(57) ABSTRACT

A second stage pressure reducer for two-stage scuba regulators, comprising gas supply chamber; an elastic diaphragm; an inlet, connected to the gas supply chamber through an orifice; a tubular element, conveying breathing gas from the orifice to the gas supply chamber; a poppet stem, housed inside the tubular element; a poppet seat, affixed to the poppet stem and causing the orifice to open or close; a poppet spring, causing the poppet stem to slide; centering tabs, protruding from the poppet stem and maintaining the poppet stem in a constant axial position and further allowing the poppet stem to slide axially; a guide system for preventing axial rotation of the poppet stem but not axial sliding; and a demand lever, causing translations of the poppet stem as a consequence of diaphragm movements. The guide system may be a system of grooves, rails or a combination thereof.

### CROSS REFERENCE TO RELATED APPLICATIONS

This application claims the benefit of foreign application IT-SV2003A000005, filed in Italy on Feb. 11, 2003 and titled “Secondo stadio di riduzione di pressione in erogatori bistadio per uso subacqueo.”

### BACKGROUND OF THE INVENTION

Two-stage scuba regulators are employed by scuba divers when accurate delivery pressure of breathing gas is important. A two-stage regulator reduces source pressure to a working level in two steps. Source pressure is reduced by a first stage pressure reducer (hereinafter, “first stage”) to a preset intermediate level and is then fed to the inlet of a second stage pressure reducer (hereinafter, “second stage”). Since the inlet pressure to the second stage is so regulated, the delivery pressure to the scuba diver is unaffected by changes in source pressure. Thus, the two-stage pressure regulator provides precise control of the gas being consumed.

FIGS. 2 and 3 illustrate the cross-section of a second stage as typical in the prior art. A gas chamber 101 supplies breathing gas to the diver and is defined at its periphery by a case 122 and a cover button 123. An inlet 102 connects case 122 to a first stage by means of a suitable hose, and the first stage is in turn connected to a high pressure source of breathing gas, typically a bottle, a cylinder or a tank. Inlet 102 includes, on the side affixed to case 122, a valve orifice 103, generally of conical or frustoconical shape. Delivery of gas to gas chamber 101 is controlled by a valve that is housed inside the second stage and that comprises a tubular element 106 comprising a poppet spring 107, a poppet stem 105, and a poppet seat 104, which poppet seat 104 is affixed to the end of poppet stem 105 facing orifice 103, and which poppet seat 104 cooperates with orifice 103. Breathing gas is fed to the diver from the first stage into tubular element 106 through orifice 103, which is opened or closed by poppet seat 104 when contractions or expansions of poppet spring 107 move poppet stem 105 away from or towards orifice 103. Gas is fed from tubular element 106 into gas supply chamber 101 and is finally fed to the diver trough a mouthpiece connected to port 111, which communicates with gas supply chamber 101.

Gas supply chamber 101 is delimited by an elastic diaphragm 108. The inner side of elastic diaphragm 108 seals gas supply chamber 101, while the outer side of elastic diaphragm 108 is exposed to hydrostatic pressure. Further, diaphragm 108 controls a demand lever 109, which demand lever 109 has a first end in contact with diaphragm 108 and a second end connected to poppet stem 105, and which rests in an essentially perpendicular to poppet stem 105 when not compressed by elastic diaphragm 108.

When the diver is not inhaling gas, helical poppet spring 107 maintains poppet stem 105 in contact position with orifice 103, thereby closing inlet 102, whereas, during inhalation, poppet stem 105 slides to open inlet 102 due to the negative pressure inside tubular element 106 and/or due to the positive pressure of the gas coming from the first stage. The tension of spring 107 is controlled by an adjustment screw, which projects out of case 122 and which is connected to the end of poppet stem 105 opposite to poppet seat 104. Such adjustment screw causes poppet spring 107 to increase or decrease axial compression on poppet stem 105 and on poppet seat 104. Spring pressure knob 110 is connected to the adjustment screw. Movements of the adjustment screw and, therefore, changes in the compression strength exercised by poppet spring 107 may be achieved by rotating spring pressure knob 110 about the longitudinal axis of poppet stem 105 and of tubular element 106.

Flexible diaphragm 108 sealably separates gas supply chamber 101 from the external environment and remains in contact with the external environment by openings in cover button 123. As hydrostatic pressure on the outer face of diaphragm 108 changes for a variety of reasons, typically, diving depth, pressure conditions inside gas supply chamber 101 are automatically balanced by means of demand lever 109, which causes poppet stem 105 to shift as a function of external hydrostatic pressure.

In order to achieve a perfect match between poppet seat 104 and orifice 103 and for the poppet valve to operate properly, poppet stem 105 and poppet seat 104 must always be perfectly coaxial with tubular element 106 and with orifice 103. With reference to FIGS. 1 and 2, poppet stem 105 retains its coaxial position with tubular element 106 and with orifice 103 by means of guiding and centering tabs 112 that protrude radially from poppet stem 105. In order for poppet stem 105 to maintain its coaxial position, the radial width of poppet stem 105, inclusive of guiding and centering tabs 113, must be substantially equal to (but not larger than) the inner diameter of tubular element 106.

Additionally, in order to allow for passage of breathing gas through tubular element 106, the cross-section of poppet stem 105, inclusive of tabs 112 must have a smaller area than the cross-section of tubular element 106. In the prior art, three or more tabs are employed, in order to allow for air passage and at the same time to prevent a misalignment or the flexing of poppet stem 105 within tubular element 106.

Three tab constructions in the prior art include a variety of other designs beyond those shown in FIGS. 1 and 2, such as three tabs of equal length arranged in a “T” configuration with the stem and the arms of the “T” having equal length and intersecting in the longitudinal axis of the poppet stem; or three tabs of unequal lengths arranged in a “T” configuration, with the stem of the “T” intersecting the longitudinal axis of poppet stem 105 and the two arms of the “T” in a position tangent or secant to poppet stem 105.

Radial ridges 119 may also extend radially from poppet stem 105, in order to retain poppet spring 107 in position and to promote the automatic adjustment of gas pressure inside the second stage as a function of external hydrostatic conditions.

Second stages of the prior art have several drawbacks. One such drawback is the relatively large number of poppet stem guiding and centering tabs 112 that are required to insure proper centering of poppet stem 105 within tubular element 106. A construction with three, four or more tabs 112 and possibly with radial ridges 119 considerably reduces the available area for passage of gas inside tubular element 105 and requires a higher inhalation effort by the diver.

Another drawback in the prior art is the undesired rotation of poppet stem 105 inside tubular element 106 when the diver turns spring pressure knob 110. Because second stages operate on air demand, a perfect seal between poppet seat 104 and orifice 103 during non-inhalation must be provided, in order to prevent a continuous supply of gas to the diver. At the same time, inhalation by the diver must require a minimum effort, or the diver may experience fatigue and possibly breathlessness. Second stage inhalation resistance, that is, the breathing effort required of the diver, can be altered by turning knob 110 and adjusting the tension of spring 107. Unfortunately, because knob 110 is connected to the end of poppet stem 105 that is opposite to the poppet seat 104, when knob 110 is rotated, poppet stem 105 may rotate at the same time, causing a rotation of poppet seat 104 relative to orifice 103. This is undesirable because the end of orifice 103 facing poppet seat 104 has an edge that is thin and sometimes sharp, while poppet seat 104 is typically made of a relatively deformable material, such as an elastomeric material. Over time, with valve usage, poppet seat 104 and orifice 103 may come to conform to each other by either or both of them deforming to an asymmetrical configuration in relation to their common axis. This may occur, for instance, because the longitudinal axis of orifice 103 is not exactly perpendicular to the opposing surface of poppet seat 104. Therefore, when poppet seat 104 rotates because of the rotation of spring pressure knob 110, the deformations of orifice 103 and poppet seat 104 may become mismatched, for instance, the deformation on the front surface of seat 104 may become angularly staggered in relation to the deformation of orifice 103. Such mismatch may cause problems in valve operation and in valve closure that divers tend to overcome by increasing the tension of spring 107. In turn, this increase in spring pressure causes both an undesirable increase in inhalation resistance and an early wear of poppet seat 104.

A further drawback in the prior art is related to the freedom of movement of poppet stem 105 during assembly of the second stage. Because in the prior art poppet stem 105 is not restrained from rotating within tubular element 106, assemblers encounter a variety of problems during second stage assembly, for instance, achieving proper positioning of the various elements of the valve.

### BRIEF SUMMARY OF THE INVENTION

This invention relates to a second stage pressure reducer for two-stage scuba regulators, and more particularly to a second stage pressure reducer wherein poppet stem rotation is prevented by means of a guide system, in the form of rails and/or grooves, that impedes the angular movement of the tabs, and wherein said guide system allows for poppet stem design with two tabs only without causing a flexing or a misalignment of the poppet stem relative to the tubular element and the orifice.

An advantage of the present invention is to eliminate the problems deriving from mutual deformations of orifice and poppet seat by locking the poppet stem tabs into a fixed radial position, while allowing for a sliding movement of the poppet stem in the direction of its longitudinal axis, by means of a guide system, in the form of appropriately positioned rails and/or grooves that prevent rotation of the poppet stem inside the tubular element but not a longitudinal movement.

Another advantage of the present invention is to increase the available passageway of breathing gas within the tubular element by reducing the number of tabs and ridges that extend radially from the poppet stem and at the same time by retaining the poppet stem in a concentric position with the orifice through a guide system, in the form of rails and/or grooves on the inner surface of the tubular element of matching rails and grooves that lock the tabs into a restrained position within the tubular element while allowing the poppet stem to slide in the longitudinal direction.

A further advantage of the present invention is to facilitate assembly of second stage pressure regulators by providing a guide system, in the form of guide rails and/or grooves that cause an easy and rapid centering of the poppet stem within the tubular element.

Yet another advantage of the present invention is to attain all the objects of the invention through the introduction of improvements over the prior art, such as the addition of guide rails and/or grooves to the tubular element of the valve and, in certain embodiments, to the tabs, that are simple and inexpensive to manufacture.

Other advantages of the present invention will become apparent from the following descriptions, taken in connection with the accompanying drawings, wherein by way of illustration and example, embodiments of the present invention are disclosed.

### BRIEF DESCRIPTION OF THE SEVERAL VIEWS OF THE DRAWINGS

FIG. 1 is a sectional view of a second stage valve with a three tab poppet stem as in the prior art.

FIG. 2 is a sectional view of a second stage valve with a four tab poppet stem as in the prior art.

FIG. 3 is a sectional view of a second stage pressure regulator as in the prior art.

FIG. 4 is an exploded view of a detail of a first embodiment of the invention.

FIG. 5 is a cross-sectional view of a detail of a first embodiment of the invention.

FIG. 6 is a cross-sectional view of a detail of a second embodiment of the invention.

FIG. 7 is a cross-sectional view of a detail of a third embodiment of the invention.

FIG. 8 is a cross-sectional view of a detail of a fourth embodiment of the invention.

FIG. 9 is a cross-sectional view of a fifth embodiment of the invention.

FIG. 10 is a cross-sectional view illustrating a detail of the embodiment of FIG. 9.

FIG. 11 is a cross-sectional view of a detail of a sixth embodiment of the invention.

FIG. 12 is a cross-sectional view of a detail of a seventh embodiment of the invention.

FIG. 13 is a cross-sectional view of a detail of an eighth embodiment of the invention.

FIG. 14 is a cross-sectional view of a detail of a ninth embodiment of the invention.

FIG. 15 is a cross-sectional view of a first embodiment of the invention.

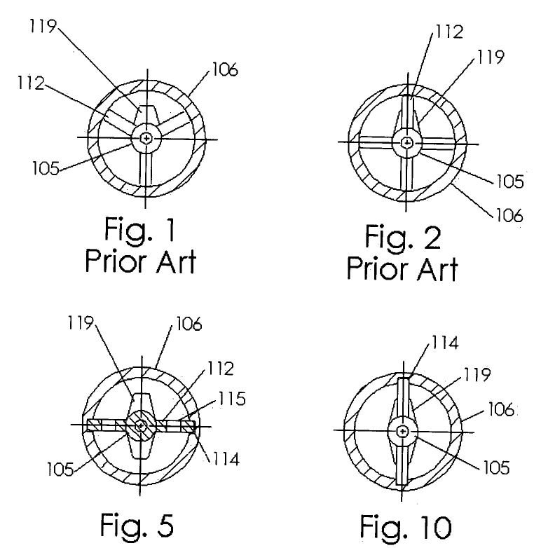

### DETAILED DESCRIPTION OF THE INVENTION

Detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as the basis for the claims and as a basis for teaching one skilled in the art how to make and/or use the invention.

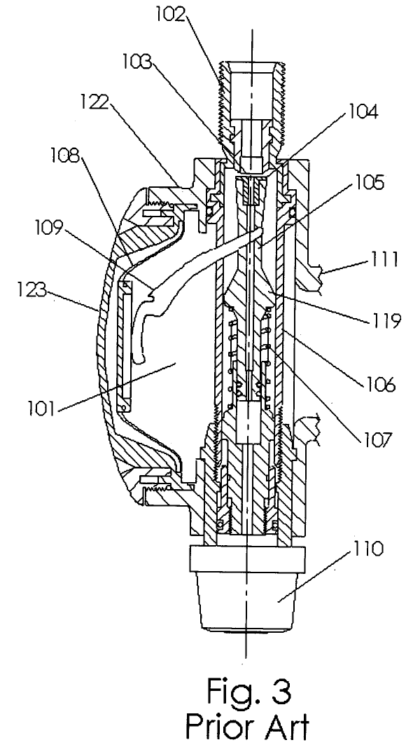

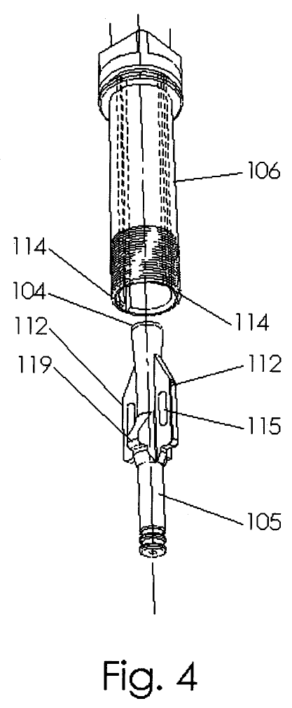

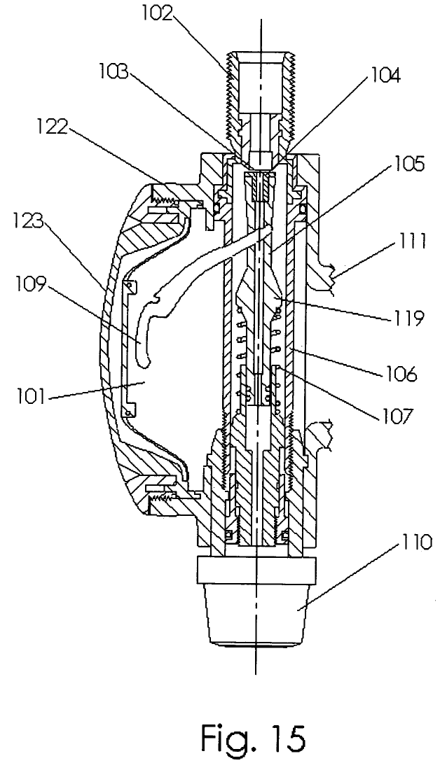

FIGS. 4 and 5 and 15 illustrate a first embodiment of the invention, which resolves the problems both of a limited gas passageway within tubular element 106 and of poppet stem rotation. In this embodiment, poppet stem 105 has a single pair of centering tabs 112 disposed in diametrically opposite positions and within a plane perpendicular to a pair of radial ridges 119, which act as retainers for poppet spring 107. Each one of centering tabs 112 has a radial width, extending between the longitudinal axis of poppet stem 105 and the peripheral edge of the tab, that is greater than the inner radius of tubular element 106.

Each one of tabs 112 is slidably engaged by its peripheral edge in a matching groove 114 that is located on the inner wall of tubular element 106 and that has the same orientation as the direction of travel of poppet stem 105. Therefore, poppet stem 105 becomes slidably guided in a perfectly straight motion within tubular element 106 and any rotation of poppet stem 105 about its longitudinal axis is prevented, causing the contact surfaces of poppet seat 104 and of orifice 103 to remain constantly matched. Because the number of tabs 112 is reduced from three or more in the previous art to two, this embodiment allows for an increased air passageway within tubular element 106 compared to the prior art.

Each one of tabs 112 may include longitudinal slots 115 for engaging demand lever 109. When diaphragm 108 causes demand lever 109 to move, poppet stem 105 slides accordingly.

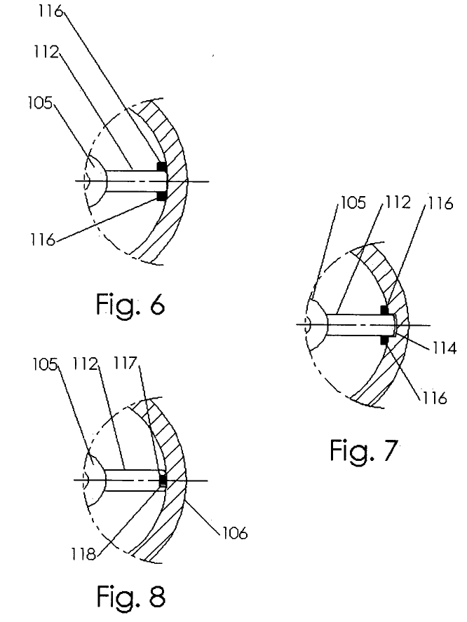

FIGS. 6, 7, and 8 illustrate other embodiments of the invention with alternative designs for allowing a sliding movement of poppet stem 105 within tubular element 106 while preventing rotation of the poppet stem 105 about its longitudinal axis.

In the embodiment illustrated in FIG. 6, the peripheral edge of each tab 112 is slidably engaged within a guide on the inner wall of tubular element 106. The guide is formed by a pair of longitudinal ribs 116 that project inward from the inner wall of tubular element 106 and that are spaced at a distance substantially equal to (but not smaller) than the thickness of one tab 112. In this embodiment, the radial width of each tab 112 is equal or smaller than the inner radius of tubular element 106.

In the embodiment illustrated in FIG. 7, longitudinal grooves 114 are situated on the inner surface of tubular element 106 and allow for a sliding movement of tabs 112 in the direction of the longitudinal axis of tubular element 106 while preventing an angular rotation of tabs 112 and consequently of poppet stem 105. At the same time, ribs 116, projecting inwardly from the inner wall of tubular element 106 so to essentially form extensions of the inner walls of groove 114, provide further restraint to the rotational movement of tabs 112 and of poppet stem 105.

In the embodiment illustrated in FIG. 8, each of the peripheral edge of tabs 112 includes a throat 117 that extends along the entire longitudinal length of the peripheral edge of each tab 112. Conversely, the inner wall of tubular element 106 includes guide rails 118 that project radially inward and that are of matching sizes and in matching positions with throats 117. During assembly of the valve, rails 118 become slidably engaged with throats 117.

FIG. 8 illustrates an embodiment with one throat 117 at the peripheral edge of each tab 112, which becomes engaged with one rail 118, but more than one throat 117 may be provided at the end of each tab 112, with a matching number of rails 118 on the inner surface of tubular element 106.

The embodiments shown in FIGS. 4-8 are illustrative rather than limiting, and equivalent grooves, throats and rails that may be different in numbers and shapes from those described herein in detail fall within the scope and spirit of the present invention. For instance, throats 117 and grooves 118 of FIG. 8 may be two or more in number, and have triangular rather that square shapes.

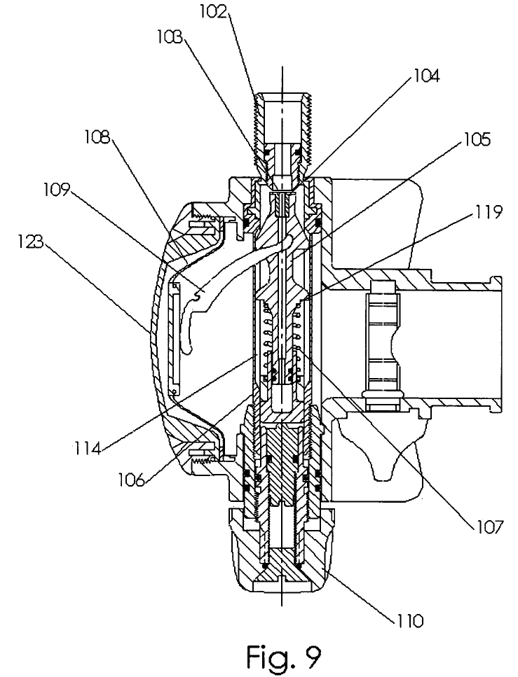

FIGS. 4, 5, 9 and 10 further show a different embodiment of the invention wherein poppet stem 105 includes radial ridges 119 that extend from poppet stem 105 in radially opposed directions and that act as retainers for poppet spring 107. At the same time, tabs 112 may engage demand lever 109, either by direct contact, or by engaging in demand lever 109 into longitudinal slots 115 on tabs 112. In one configuration, tabs 112 extend from radial ridges 119 and are angularly but not longitudinally restrained, providing for a slidable engagement of poppet stem 105 within tubular element 106 and at the same time preventing the rotation of poppet stem 105 within tubular element 106. Tabs 112 may have the same or different longitudinal lengths as ridges 119, and may have radial axes that are in the same longitudinal position or that are longitudinally offset with reference to the longitudinal axis of poppet stem 105. Further, more than one pair of tabs 112 may be provided along the longitudinal axis of poppet stem 105. FIG. 9 shows a configuration wherein tabs 112 are provided in two pairs that are co-planar and that are longitudinally spaced along the axis of poppet stem 105, each of these two pairs being engaged in longitudinal grooves 114 that are shaped in the inner wall of tubular element 106.

All means for engaging centering tabs 112 to tubular element 106 that were described in relation to the previous embodiments are applicable to this embodiment as well, namely, tabs 112 extending from radial ridges 119 may be engaged to tubular element 106 by having a radial extension larger than the inner radius of tubular element 106 and by being slidably engaged in grooves on the inner surface of tubular element 106; or by having a radial extension that is substantially equal to the inner radius of tubular element 106 and by being restrained in position by pairs of ribs protruding inwards from the inner surface of tubular element 106; or by having throats in their peripheral edges that are slidably engaged into matching guide rails on the inner surface of tubular element 106; or by different combinations of these restraining means.

One of the specific advantages of the embodiment illustrated in FIGS. 9 and 10 is the increase in the air passageway compared to the prior art and even other embodiments described herein, due to the employment of only two small tabs and to the longitudinal alignment of ribs and small tabs.

In any of the heretofore described embodiments that exhibit two or more tabs 112, rotation of poppet stem 105 does not require that each tab 112 be engaged to the inner surface of tubular element 106. Instead, rotation of poppet stem 105 may be prevented by engaging only one or more of tabs 112. FIGS. 12-14 show examples of embodiments, in which not all tabs 112 are engaged to tubular element 106.

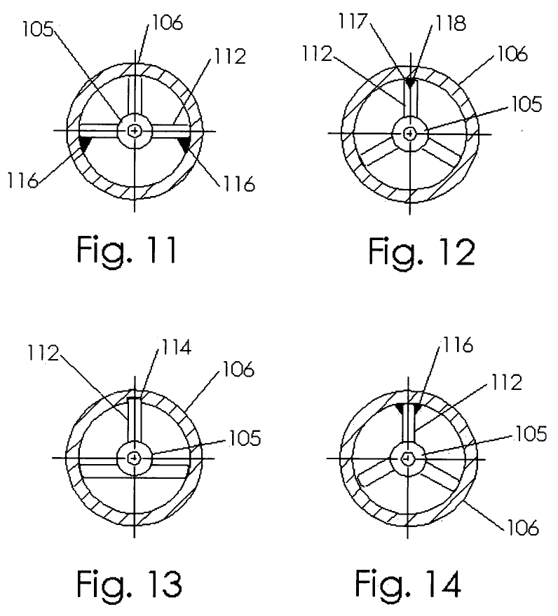

For instance, FIG. 11 illustrates one embodiment with three tabs 112, wherein, instead of providing a guide for each tab 112 preventing rotation of poppet stem 105, two of the three tabs 112 are each restrained from angular rotation by one radial rib 116 that projects inward from the inner surface of tubular element 106, with one radial rib 116 preventing clockwise rotation and another preventing counter-clockwise rotation. The two tabs 112 that are in contact with ribs 116 need not be opposed to each other, so, for instance, in the embodiment shown in FIG. 11, where the three tabs 112 are arranged in a “T” position, two ribs 16 may restrain angularly the tabs that form the arms of the “T”, or may instead restrain angularly one arm of the “T” and the stem of the “T.”

The restraining systems illustrated in FIGS. 11-14 apply equally to configurations of poppet stem 105 with only two tabs 112, such as the designs of poppet stem 105 shown in FIGS. 5 and 10. Additionally, other configurations of poppet stem 105 with two tabs 112 may also be restrained with two ribs 116 in the manner shown in FIG. 11 or 14, or with a throat 117 and a guide rail 118 in the manner shown in FIG. 12, or with a single groove in the manner shown in FIG. 13. Configurations wherein the two tabs 112 do not extend radially from the axis of poppet stem 105 but are instead situated in a position that is secant or tangent to the body of poppet stem 105 may be restrained in the same manner.

The present invention relates not only to designs of poppet stem 105 that include tabs 112 that constitute each a single piece along the axial direction of poppet stem 105, but also to designs of poppet stem 105 wherein there are multiple groups of tabs 112 or small tabs 120 that are spaced along the axial direction of poppet stem 105.

While the invention has been described in connection with a number of embodiments, it is not intended to limit the scope of the invention to the particular forms set forth, but on the contrary, it is intended to cover such alternatives, modifications, and equivalents as may be included within the spirit and scope of the invention as defined in the appended claims.

What is claimed is:

1. A second stage pressure reducer for two-stage scuba regulators, comprising:
a gas supply chamber, communicating with a mouthpiece;
an elastic diaphragm, having an inner face that delimits said gas supply chamber and that seals said gas supply chamber from the external environment, and having an outer face that is exposed to external hydrostatic pressure;
an inlet, having a proximal end that is connected to said gas supply chamber and a distal end that is connected to a first stage pressure reducer, said proximal end containing a valve orifice, and said first stage pressure reducer being in turn connected to a source of breathing gas;
a tubular element, contained in said gas supply chamber and conveying said gas from said inlet through said orifice into said gas supply chamber;
a poppet stem, housed inside said tubular element and having the same longitudinal axis as said tubular element, said poppet stem further having a body of smaller radial size than said tubular element;
a poppet seat, affixed to that end of said poppet stem that faces said orifice, said poppet seat causing said orifice to close when said poppet seat is driven into contact with said orifice and causing said orifice to open when said poppet seat is removed from contact with said orifice;
a poppet spring, connected to that end of said poppet stem that is opposite to said poppet seat, said poppet spring causing said poppet stem to slide along said tubular element away from said orifice when said poppet spring is compressed;
centering tabs, protruding from said poppet stem and causing said poppet stem to retain a constant axial position within said tubular element, said centering tabs further allowing said poppet stem to slide axially within said tubular element;
first means for preventing said poppet stem from rotating about said poppet stem's longitudinal axis, said first means further allowing said poppet stem to slide axially; and
a demand lever, having a first end and a second end, said first end being in contact with said diaphragm and being caused to move by movements of said diaphragm, and said second end being joined to said poppet stem, thereby causing said poppet stem to slide as a consequence of movements of said first end.

2. A second stage pressure reducer as in claim 1, wherein the first means for preventing the poppet stem from rotating about the longitudinal axis of said poppet stem restrain at least one of the centering tabs while allowing said tabs to slide in the direction of said longitudinal axis.

3. A second stage pressure reducer as in claim 2, wherein the tabs being restrained have a radial length in excess of the distance between said poppet stem and the inner wall of the tubular element, and wherein each of said tab or tabs is engaged in a longitudinal groove on said inner wall, said groove running in a direction parallel to the axis of said tubular element and preventing a rotation of said poppet stem, said groove further allowing said poppet stem to slide in the axial direction of said poppet stem.

4. A second stage pressure reducer as in claim 3, wherein at least one of the tabs engaged in the longitudinal grooves is further restrained by one or two longitudinal ribs running parallel to said grooves, said ribs being situated in the proximity of said tabs and projecting inwards from the inner surface of said tubular element.

5. A second stage pressure reducer as in claim 4, wherein the peripheral edges of the tabs are substantially flush with the inner surface of the tubular element.

6. A second stage pressure reducer as in claim 2, wherein the tabs being restrained are each slidably engaged in guides on the inner wall of the tubular element, said guides being formed by pairs of longitudinal ribs running in a direction parallel to the axis of said tubular element, said ribs projecting inwards from the inner surface of said tubular element and said ribs being spaced at a distance substantially equal to but not smaller than the thickness of said tab.

7. A second stage pressure reducer as in claim 2, wherein the peripheral edges of the tabs being restrained include one or more throats in a longitudinal direction parallel to the axis of the tubular element and wherein the inner wall of said tubular element includes inward projecting ribs, said inward projecting ribs having shapes, numbers and positions that match and that slidably engage said throats.

8. A second stage pressure reducer as in claim 2, wherein the poppet stem has two tabs only.

9. A second stage pressure reducer as in claim 8, wherein the second end of the demand lever is engaged to one or both of the tabs, and wherein movements of the elastic diaphragm cause a movement of the poppet stem due to the engagement of said demand lever with said tabs.

10. A second stage pressure reducer as in claim 9, wherein the demand lever is engaged in one or more longitudinal slots on the tabs.

11. A second stage pressure reducer as in claim 8, wherein the two tabs are oriented in diametrically opposite positions with reference to the poppet stem.

12. A second stage pressure reducer as in claim 8, wherein rotation of the poppet stem is prevented by two ribs that project inward from the inner wall of the tubular element, one of said ribs being positioned adjacent to the clockwise side of one of said tabs and the other one of said ribs being positioned adjacent to the counter-clockwise side of the other one of said tabs.

13. A second stage pressure reducer as in claim 8, further including second means for engaging the poppet spring in position against the poppet stem, said second means being separate from the tabs.

14. A second stage pressure reducer as in claim 13, wherein the second means comprise one or more ridges extending from the body of the poppet stem, said ridges having radial axes that are transverse or perpendicular to the radial axes of said tabs.

15. A second stage pressure reducer as in claim 13, wherein the second means comprise one or more ridges extending from the body of the poppet stem, and wherein at least one of the tabs extends from said ridges, said tab having the same radial axis as said ridges and said tab being situated in the same axial portion of said poppet stem as said ridges.

16. A second stage pressure reducer as in claim 15, wherein the second means consist of two ridges extending from the body of the poppet stem, and wherein each tab extends from one of said ridges, said tabs having lengths different from said ridges and said tabs being offset from each other in relation to the longitudinal axis of said poppet stem.

17. A second stage pressure reducer as in claim 15, wherein the ridges and the tabs extending from said ridges have substantially the same longitudinal length.

18. A second stage pressure reducer as in claims 15, wherein the two tabs are in contact with the second end of the demand lever.

19. A second stage pressure reducer as in claims 15, wherein the second end of the demand lever is engaged to one or both of the tabs, whereby movements of the elastic diaphragm cause a movement of the poppet stem due to the engagement of said demand lever with said tabs.

20. A second stage pressure reducer as in claim 2, wherein the poppet stem has three centering tabs, each of said tabs having a radial axis that either intersects the longitudinal axis of said poppet stem or that lies in a longitudinal plane that is secant or tangent to the body of said poppet stem.

21. A second stage pressure reducer as in claim 20, wherein two of the three tabs lie in substantially the same plane and are substantially opposite to each other.

22. A second stage pressure reducer as in claim 2, wherein each of the tabs is a single longitudinal extension from the poppet stem and wherein the length of said longitudinal extension is the same for all of said tabs.

23. A second stage pressure reducer as in claim 2, wherein each of the tabs is a single longitudinal extension from the poppet stem and wherein at least one of said tabs is of different longitudinal length.

24. A second stage pressure reducer as in claim 2, wherein within a longitudinal plane that contains the axis of the poppet stem or that is secant or tangent to said poppet stem, more than one tab is provided, said tabs being longitudinally spaced from each other.
